(19) United States
(12) Patent Application Publication
(10) Pub. No.: US 2005/0102427 A1
(43) Pub. Date: May 12, 2005

(54) Stream contents distribution system and proxy server

(76) Inventors: Daisuke Yokota, Yokohama (JP); Fumio Noda, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/241,485

(22) Filed: Sep. 12, 2002

(30) Foreign Application Priority Data
Aug. 9, 2002 (JP) 2002-232679

(51) Int. Cl. G06F 15/16

(52) U.S. Cl. 709/245

(57) ABSTRACT

A proxy server for storing contents data extracted from a contents packet received from a stream server as cache data of stream contents into a cache file and transferring the received packet to a contents requester after rewriting the address of the received packet, having a function for requesting the stream server to stop providing service of the stream contents and requesting another proxy server to transfer the remaining portion of the stream contents.

### BACKGROUND OF THE INVENTION

(1) Field of the Invention

The present invention relates to a stream contents distribution system and a proxy server and, more particularly, to a stream contents distribution system and a proxy server enabling a load balancing in a stream server.

(2) Description of the Related Art

As the bandwidth of a network such as the Internet becomes wider, stream contents distribution service through a network came to be realized. In stream contents distribution service (hereinbelow, called stream service) such as video on demand, a contents request message is sent from a user terminal (hereinbelow, called a client) to a stream server as a distributor of stream contents, and the stream server transmits a series of packets including the requested stream contents to the client in response to the, request, thereby reproducing the stream at the client.

In the stream service, to accept the contents request from any number of clients, a plurality of servers as suppliers of the stream contents have to be prepared. As the scale of the stream service is becoming large, a load balancing type system configuration is employed in which a plurality of stream servers disposed in parallel like network topology are connected to a network via a switch and contents requests are distributed to the stream servers by the switch in accordance with, for example, a load balancing algorithm such as a round robin fashion. However, if stream contents as the target of service are uniformly provided for all of the stream servers so that the contents request allocated by the switch is processed by an arbitrary server, a large contents file (storage) is necessary for each of the servers.

In the stream service, the following system configurations directed to effectively use a storage for accumulating contents data are known.

In a first type of the system configuration, stream servers have different contents and, when a contents request is received, the contents request is allocated to a specific server having the requested contents, thereby to transmit the contents data to a client.

In a second type of the system configuration, a plurality of stream servers share a contents file, and each stream server accepts an arbitrary contents request, reads out the requested contents from the shared file, and transmits the contents to the client.

In a third type of the system configuration, a plurality of servers forming the first type of system configuration are provided with copies of stream contents which is frequently requested so that the plurality of servers can respond to contents requests to a popular stream.

In a fourth type of the system configuration, a plurality of proxy servers are disposed before a stream server. Each of the proxy servers is allowed to store frequently requested stream contents therein as cache data and to response to the contents request from a client by using the cache data.

Since the size of stream contents is larger as compared with contents data in the normal Web service, the load on a network and a server is heavy. Particularly, in the first type of the system configuration, when requests from clients are concentrated on specific stream contents, the load is concentrated on a server providing the specific stream, and it becomes difficult to sufficiently deal with the requests from the clients.

In the second type of the system configuration, a number of contents requests to a specific stream can be accepted by a plurality of servers. However, since a contents file is shared by the plurality of servers, a high-performance storage accessible at high speed is necessary.

In the third type of the system configuration, it is difficult to predict the contents which is frequently requested and a work for loading copies of the contents to a plurality of servers is required. Consequently, the operation cost of the system becomes high.

The fourth type of the system configuration has an advantage that popular contents having been requested at high frequency can be automatically accumulated as cache data into a proxy server. However, the data size of stream contents is large, and invalidation of old cache data occurs frequently in order to prepare a storage area for new cache data due to constraints on capacity of a cache file. Further, when cache data of the contents requested by a client is not in the cache file of a proxy server, the proxy server has to access the stream server having the original contents even if the requested cache data exists in another proxy server. There is consequently a problem on use of the cache data in this system configuration. This problem can be solved if the cache data available to every proxy server.

However, if a method that a proxy server which does not have requested cache data inquires the other proxy servers of the presence or absence of the target cache data is employed, the amount of control messages to be communicated among the proxy servers increases so that overhead for sharing the cache cannot be ignored. Japanese Unexamined Patent Application No. 2001-202330 proposes a cluster server system wherein a network switch grasps the state of the cache data of all the servers to selectively allocate a contents request to a proper server having the required cache data. In this case, the network switch has to have a special function of grasping the cache state on the servers in spite of that the communication loads are concentrated thereon. Consequently, a relatively cheap network switch, for example, a general type of switch for allocating the contents requests to the plurality of servers in a round robin fashion cannot be employed.

### SUMMARY OF THE INVENTION

An object of the present invention is to provide a stream contents distribution system and a proxy server capable of realizing stream service by sharing cache data by a plurality of proxy servers.

Another object of the invention is to provide a stream contents distribution system and a proxy server capable of realizing stream service while effectively using cache data and applying a network switch having no special function for grasping the cache state.

To achieve the object, the invention provides a proxy server comprising: a file for storing contents data extracted from contents packets received from a stream server as cache data of stream contents; means for transferring the contents packets received from said stream server to a contents requester after rewriting address information of the received packet; and means for requesting the stream server as a source of the contents packets to stop the stream contents providing service and requesting another proxy server to transfer the remaining portion of the stream contents.

Another feature of the invention resides in that the proxy server has a function of reading out, when a contents request is received from another proxy server, stream contents matching with the request from the file and transmitting the stream contents in a form of a series of contents packets to a requester proxy server.

More specifically, a proxy server of the invention is further comprised of: means for reading out stream contents from the file when a contents request is received from a client and the stream contents designated by the contents request exists as cache data in the file, and transmitting the stream contents in a form of a series of contents packets to the requester client; means for requesting the stream server to transmit stream contents when the stream contents designated by the contents requester does not exist as cache data in the file; and means for transmitting a notification of request accept including a contents ID designated by the contents request to a management server, wherein a providing service stop request to the stream server and a stream contents transfer request to another proxy server are issued in accordance with a response to the notification from the management server.

A stream contents distribution system of the invention is comprised of: at least one stream server for providing stream contents distributing service in response to a contents request; a plurality of proxy servers each having a file for storing the stream contents as cache data; and a switch for performing packet exchange among the proxy servers, the stream server, and a communication network and allocating contents requests received from the communication network to the proxy servers; and each of the proxy servers includes: means for reading out, when a contents request is received from a client and stream contents designated by the contents request exists as cache data in the file, the stream contents from the file and transmitting the stream contents in a form of a series of contents packets to the requester client; means for requesting the stream server to transmit the stream contents when the contents data designated by the contents request does not exist as cache data in the file; means for storing, when a contents packet is received from the stream server, the contents data extracted from the received packet as cache data of the stream contents into the file, and transferring the received packet to a contents requester after rewriting address information of the received packet; and means for requesting the stream server to stop contents providing service and requesting another proxy server to transfer the remaining portion of the stream contents.

In an embodiment of the invention, the stream contents distribution system further includes a management server for performing communication with each of the proxy servers via the switch and collecting management information regarding cache data held by each of the proxy servers, and is characterized in that each of the proxy servers transmits a notification of request accept including a contents ID designated by the contents request to the management server and, in accordance with a response to the notification from the management server, issues a contents providing service stop request to the stream server and a stream contents transfer request to another proxy server.

In this case, the management server determines the presence or absence of cache data corresponding to a contents ID indicated by the notification of request accept in accordance with the management information and the management server returns the response designating a relief proxy server to the proxy server as the source of the notification when the cache data exists in another proxy server.

With the configuration of the invention, even in the case of allocating contents requests to proxy servers irrespective of the contents IDs, cache data can be shared by a plurality of proxy servers, and the load on the stream server can be reduced. By providing a plurality of proxy servers with cache data of the same stream contents, the requests on the popular stream contents can be processed by the plurality of proxy servers in parallel.

The other objects and features of the invention will become apparent from the following description of the embodiments.

### BRIEF DESCRIPTION OF THE DRAWINGS

FIG. 1 is a diagram showing a schematic configuration of a network system to which a proxy server of the invention is applied.

FIG. 2 is a diagram for explaining the relation between stream contents and contents packets.

FIG. 3 is a diagram for explaining a method of distributing stream contents by the proxy server of the invention.

FIG. 4 is a diagram showing the configuration of a proxy server 5.

FIG. 5 is a diagram showing the configuration of a management server 6.

FIG. 6 is a diagram showing an example of a connection table 67 of the management server 6.

FIG. 7 is a diagram showing an example of a cache table 68 of the management server 6.

FIG. 8 is a diagram showing an example of a load table 69 of the management server 6.

FIG. 9 is a diagram showing the main part of a flowchart showing an example of a request processing routine 500 executed by the proxy server 5.

FIG. 10 is a diagram showing the remaining part of the request processing routine 500.

FIG. 11 is a diagram showing an example of a message format of a contents request M1 transmitted from a client.

FIG. 12 is a diagram showing an example of the message format of a notification of request accept M3 transmitted from a proxy server to a management server.

FIG. 13 is a diagram showing an example of the message format of notification of response end M4 transmitted from the proxy server to the management server.

FIG. 14 is a diagram showing an example of the message format of a response to request accept notification M5 transmitted from the management server to the proxy server.

FIG. 15 is a flowchart showing an example of a notification processing routine 600 executed by the management server 6.

FIG. 16 is a diagram showing a message flow in the case where a proxy server 5a having received a contents request does not have cache data of the requested contents.

FIG. 17 is a diagram showing a message flow in the case where the proxy server 5a having received the contents request has cache data of the requested contents.

FIG. 18 is a diagram showing a message flow in the case where another proxy server 5b has cache data of the requested contents.

### DESCRIPTION OF THE PREFERRED EMBODIMENTS

Embodiments of the invention will be described hereinbelow with reference to the drawings.

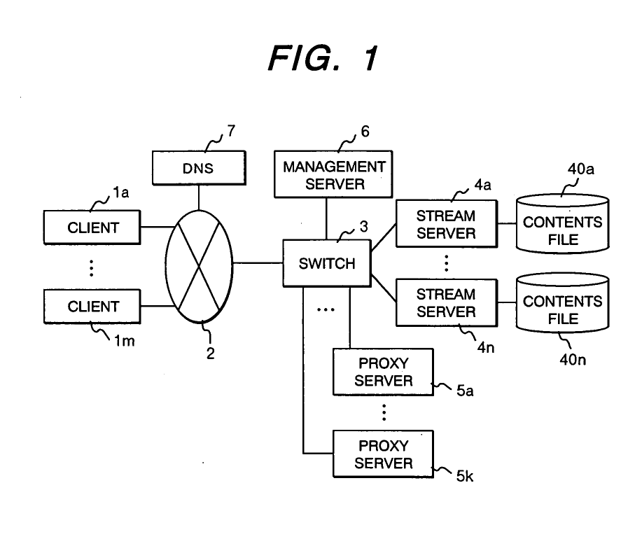

FIG. 1 shows a schematic configuration of a network system to which a proxy server of the invention is applied.

Client terminals (hereinbelow, simply called clients) 1a to 1m are connected to a switch 3 via the IP network 2. The switch 3 serves as an access point of stream service sites constructed by stream servers 4a to 4n, proxy servers 5a to 5k, and a management server 6. Each client transmits a contents request designating the ID of stream contents desired to be obtained (hereinbelow, called contents ID) to the switch 3. The switch 3 allocates the contents requests to the proxy servers 5a to 5k without depending on the contents IDs in accordance with a balancing algorithm such as round robin, thereby balancing the loads on the proxy servers 5a to 5k. Numeral 7 denotes a DNS (Domain Name Server) connected to the IP network 2, and 40a to 40n indicate contents files (storage devices) for storing stream contents of the stream servers 4a to 4n, respectively.

When the contents request is received from the switch 3, each proxy server 5 (5a to 5k) refers to an address table and obtains the address of the stream server providing the stream contents specified by the contents ID. When the stream server address corresponding to the contents ID is not registered in the address table yet, the proxy server 5 inquires the DNS 7 of the address of the stream server by designating the contents ID. After that, the proxy server 5 rewrites the destination address included in the header of the contents request to the stream server address, rewrites the source address to the address of itself, and outputs the resultant packet to the switch 3.

The contents request having the converted address is transferred by the switch 3 to a specific server indicated by the destination address, for example, the stream server 4a. The stream server 4a having received the contents request reads out the stream contents specified by the contents ID indicated by the contents request, divides the stream contents into a plurality of data blocks, and transmits them in a form of a series of data packets to the proxy server as a requester.

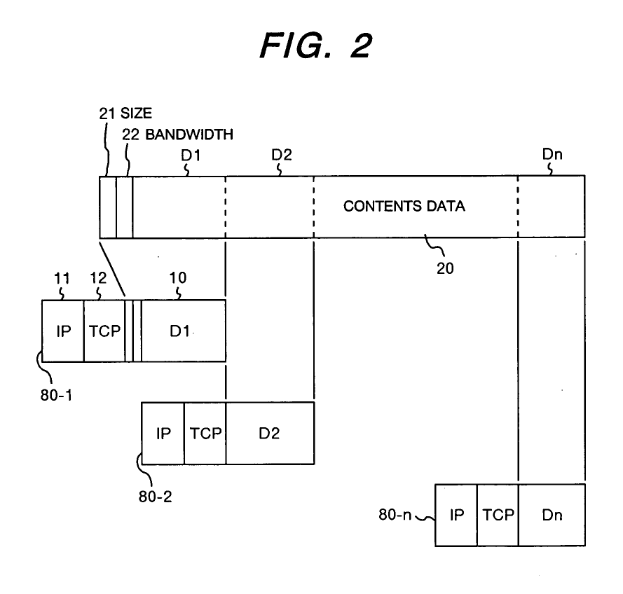

FIG. 2 shows the relation between a stream contents 20 read out from the contents file 40a and transmission packets.

At the head portion of the stream contents 20 to be sent, values of data size 21 and a bandwidth 22 necessary for transmitting the stream contents are set as control parameters. The stream server 4a divides the contents data including the control parameters into a plurality of data blocks D1, D2, . . . each having a predetermined length, adds an IP header 11 and a TCP header 12 to each data block 10, and transmits the resultant as a plurality of IP packets 80 (80-1 to 80-n) to the switch 3. Since the last data block Dn has an odd length, the length of the last IP packet 80-n is shorter than the other packets.

Since the address of the requester proxy server is set as the destination address of each of the IP headers 11, each IP packet is transferred from the switch 3 to the requester proxy server, for example, the proxy server 5a. The proxy server 5a rewrites the destination address of the IP packet to the address of a client which is the source of the contents request, rewrites the source address to the switch address which was the destination address of the contents request, and transmits the resultant packet to the switch 3. By the operations, the IP packets including the contents data transmitted from the stream server 4a are transferred to the requester client one after another via the switch.

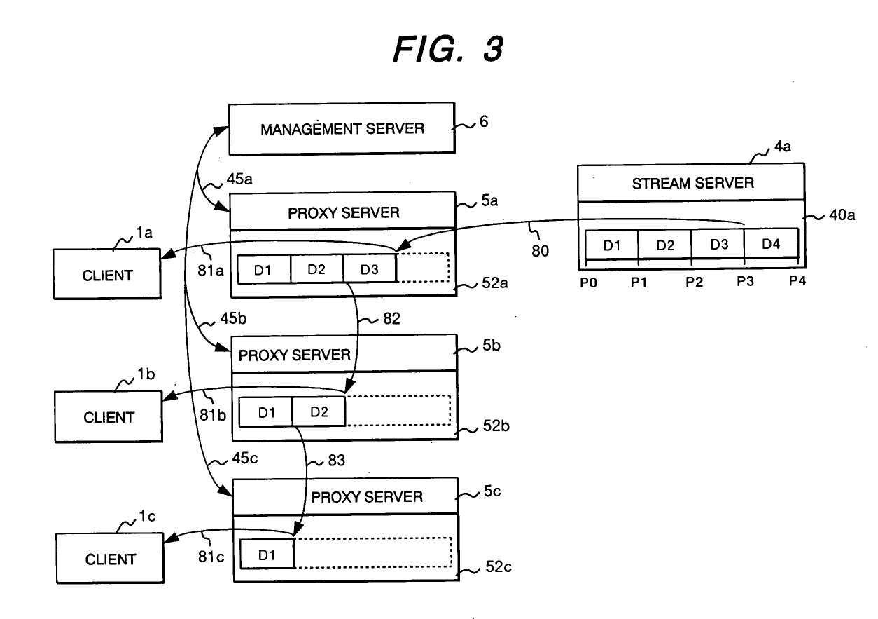

FIG. 3 shows a method of distributing stream contents by the proxy server of the invention.

The stream server 4a divides stream contents into a plurality of blocks (D1 to D4) and transmits them as the IP packets 80 (80-1 to 80-n) to the proxy server 5a as a requester. The proxy server 5a transfers the received contents data as IP packets 81a (81a-1 to 81a-n) to the requester user terminal, for example, the client 1a, and stores the data as cache data into a cache file 52a. P0 to P4 indicate boundary positions of the divided blocks in the stream contents.

When another user terminal, for example, the client 1b issues a contents request of the same stream contents 80 and the request is received by the proxy server 5b during the proxy server 5a is transferring the contents data 80 to the client 1a or after completion of the providing service of the contents 80, in the present invention, as shown by an arrow 82, by supplying contents data read out from the cache file 52a of the proxy server 5a to the proxy server 5b, service of providing the same stream contents in parallel can be realized by the two proxy servers 5a and 5b.

By accumulating the stream contents supplied from the proxy server 5a into a cache file 52b of the proxy server 5b, for example, when the proxy server 5c further receives a request of the same stream contents from the client 1c, as shown by an arrow 83, the contents data can be supplied from the proxy server 5b to the proxy server 5c. Therefore, according to the invention, stream contents providing service from a proxy server to a client can be realized while reducing the load on the stream server 5a.

The status of cache data in each proxy server is managed by the management server 6 as will be described hereinlater. Transfer of cache data among proxy servers is executed by, as shown by arrows 45a to 45c, transmission/reception of a control message between the management server 6 and the proxy servers 5a to 5c and a contents (cache data) transfer request from the requester proxy server to the source proxy server.

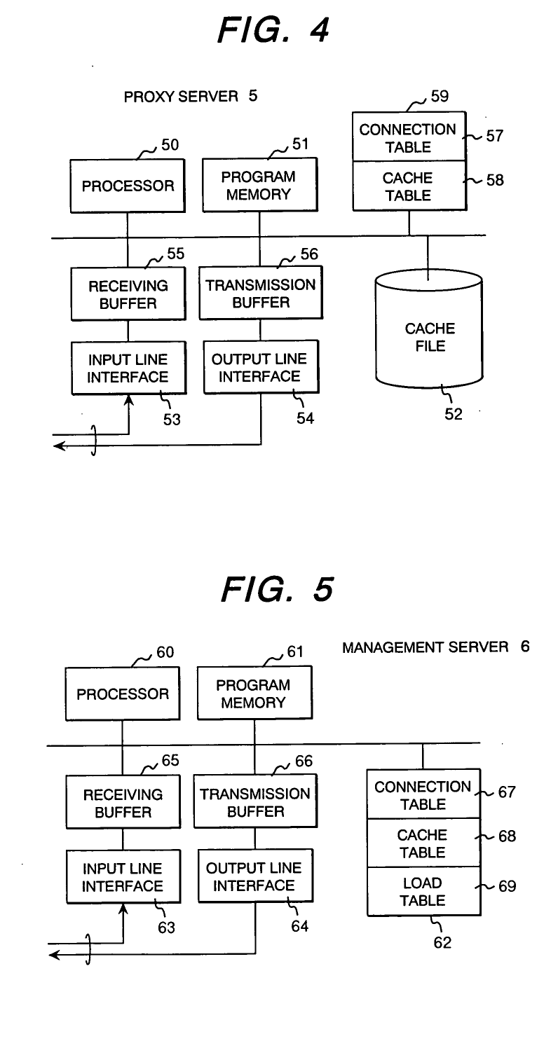

FIG. 4 shows the configuration of the proxy server 5 (5a to 5k).

The proxy server 5 includes a processor 50, a program memory 51 storing various control programs to be executed by the processor 50, a cache file 52 for storing stream contents as cache data, an input line interface 53 and an output line interface 54 for performing communication with the switch 3, a receiving buffer 55 for temporarily storing packets received by the input line interface 53, a transmission buffer 56 connected to the output line interface 54 for temporarily storing transmission packets, and a data memory 59. In the data memory 59, a connection table 57 and a cache table 58 which will be described hereinlater are formed.

FIG. 5 shows the configuration of the management server 6.

The management server 6 includes a processor 60, a program memory 61 storing various control programs executed by the processor 60, an input line interface 63 and an output line interface 64 for performing communication with the switch 3, a receiving buffer 65 for temporarily storing packets received by the input line interface 63, a transmission buffer 66 connected to the output line interface 64 for temporarily storing transmission packets, and a data memory 62. In the data memory 62, a connection table 67, a cache table 68, and a load table 69 are formed as will be detailed hereinafter.

Although each of the proxy server 5 and the management server 6 has an input device and an output device with which the system administrator can input data, these elements are not shown in the drawing because they are not directly related to the operation of the invention.

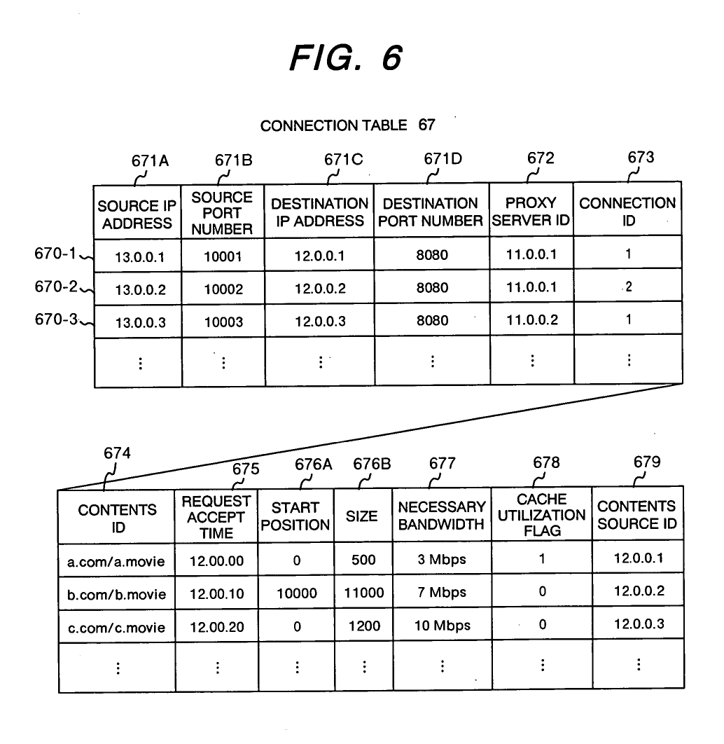

FIG. 6 shows an example of the connection table 67 of the management server 6.

The connection table 57 of each proxy server 5 has a configuration basically similar to that of the connection table 67 of the management server 6, so that FIG. 6 will be referred to for the purpose of explaining the connection table 57. Registered entries in the connection table 57 are limited to the entries peculiar to each proxy server.

The connection table 67 is comprised of a plurality of connection entries 670-1, 670-2, . . . for managing contents requests being processed by the proxy servers 5a to 5k. Each of the entries is generated on the basis of a notification of request accept M3 (FIG. 12) received by the management server 6 from each of the proxy servers. Each of the entries in the connection table 57 of the proxy server is generated on the basis of a contents request (message) M1 received by each proxy server from the client and control parameters added to the first contents packet received from the stream server.

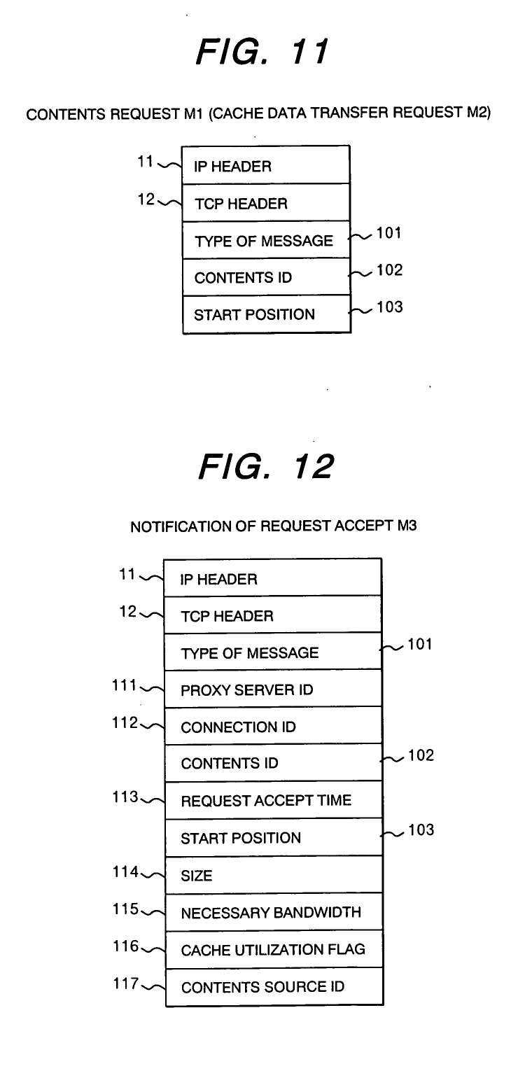

The contents request M1 includes, for example, as shown in FIG. 11, subsequently to the IP header 11 and the TCP header 12, a type 101 of message, a contents ID 102, and a start position 103 indicative of the head position of the contents data from which the user desires to receive the stream contents.

Each of entries in the connection tables 67 and 57 includes a source IP address 671A, a source port number 671B, a destination IP address 671C, a destination port number 671D, a proxy server ID 672, a connection ID 673, a contents ID 674, request accept time 675, a start position 676A, a size 676B, a necessary bandwidth 677, a cache utilization flag 678, and a contents source ID 679.

In the connection table 57 of each proxy server, as the source IP address 671A and the source port number 671B of each entry, values of the source IP address and the source port number extracted from the IP header 11 and the TCP header 12 of the contents request M1 are set. As the destination IP address 671C and destination port number 671D, values of the destination IP address of the IP header and the destination port number of the TCP header added to the contents request M1′ transferred from the proxy server to the stream server are set. Accordingly, the destination address 671C indicates the IP address of the stream server.

The contents request M1′ is the same as the contents request M1 shown in FIG. 11 except that the IP header and the TCP header are different from those in the contents request M1. In the TCP header of the contents request M1′, as the source port, a peculiar port number assigned to each connection of the proxy server (hereinbelow, called proxy port number) is set.

In the connection table 67 of the management server, as the source IP address 671A, source port number 671B, destination IP address 671C, and destination port number 671D of each entry, values of a source IP address, a source port number, a destination IP address and a destination port number extracted from the IP header 11 and the TCP header 12 added to the notification of request accept M3 are set.

The proxy server ID 672 indicates the IP address of a proxy server which is processing the contents request M1, and the connection ID 673 indicates the ID (management number) of the connection management entry in the proxy server. The contents ID 674 indicates the value of the contents ID designated by the contents request M1, and the request accept time 675 indicates time at which the contents request M1 is accepted by the proxy server. As the start position 676A, the value designated as the start position 103 by the contents request M1 is set. As the size 676B, the value of the size 21 notified from the stream server is set. By the start position 676A and the size 676B, the range of the contents data stored as cache data in the proxy server is specified for each stream contents.

As the necessary bandwidth 677, the value of the bandwidth 22 notified from the stream server is set. The cache utilization flag 678 indicates whether the cache data is used for the contents providing service in response to the contents request M1. The contents source ID 679 indicates the ID of a stream server or proxy server as a source of the stream contents.

In addition to the items 671A to 679 shown in FIG. 6, each entry of the connection table 57 for the proxy server includes the above-described proxy port number in order to correlate a contents packet transmitted from the stream server in response to the contents request M1′ with address information of the requester client.

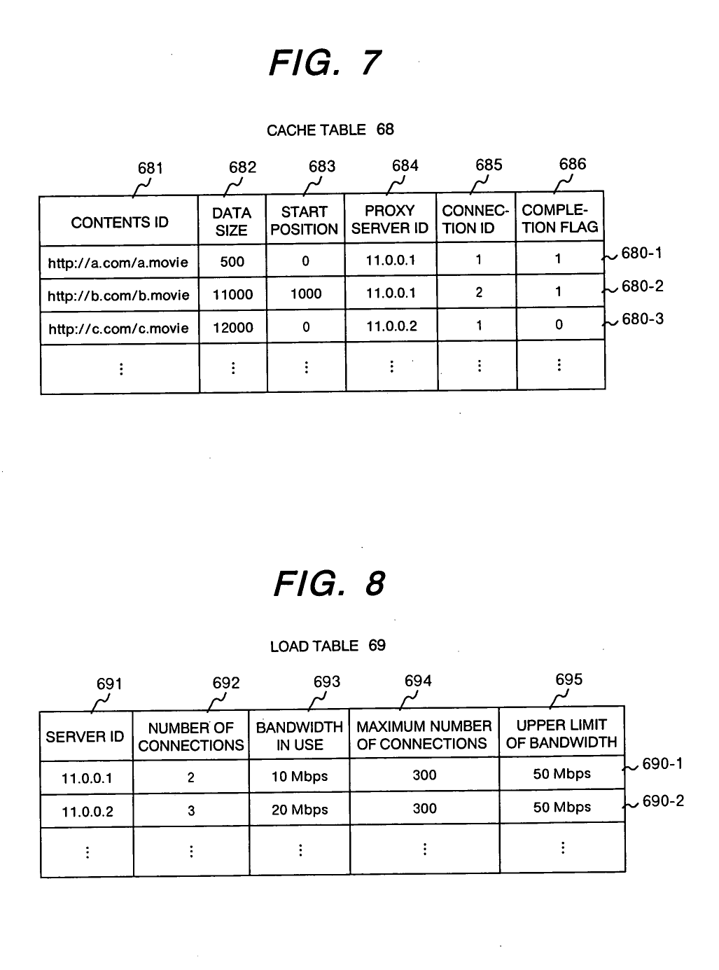

FIG. 7 shows an example of the cache table 68.

The cache table 68 is used to retrieve the stream contents stored as cache data in the proxy servers 5a to 5k and their residence. In the cache management table 68, a plurality of entries 680-1, 680-2, . . . are registered. Each entry includes contents ID 681, data size 682, start position 683, proxy server ID 684, connection ID 685, and completion flag 686. The completion flag 686 indicates either the proxy server is storing cache data (“0”) or has completed the storing operation (“1”).

The cache table 58 of each proxy server 5 has a configuration similar to that of the cache table 68 shown in FIG. 7. The registration entries are limited to the entries peculiar to each proxy server.

FIG. 8 shows an example of the load table 69.

The load table is used to indicate the load state of the proxy servers 5a to 5k and is comprised of a plurality of entries 690-1, 690-2, . . . corresponding to IDs 691 of the proxy servers 5a to 5k. Each entry includes, in correspondence with the server ID 691, the number 692 of connections, a bandwidth 693 in use, a maximum number 694 of connections, and an upper limit 695 of bandwidth. The values of the maximum number 694 of connections and the upper limit 695 of bandwidth are designated by the system administrator when the proxy server is joined to the service site. The number 692 of connections indicates the number of contents requests presently being processed by each proxy server, and the bandwidth 693 in use indicates the total value of the communication bandwidth being used by the connections.

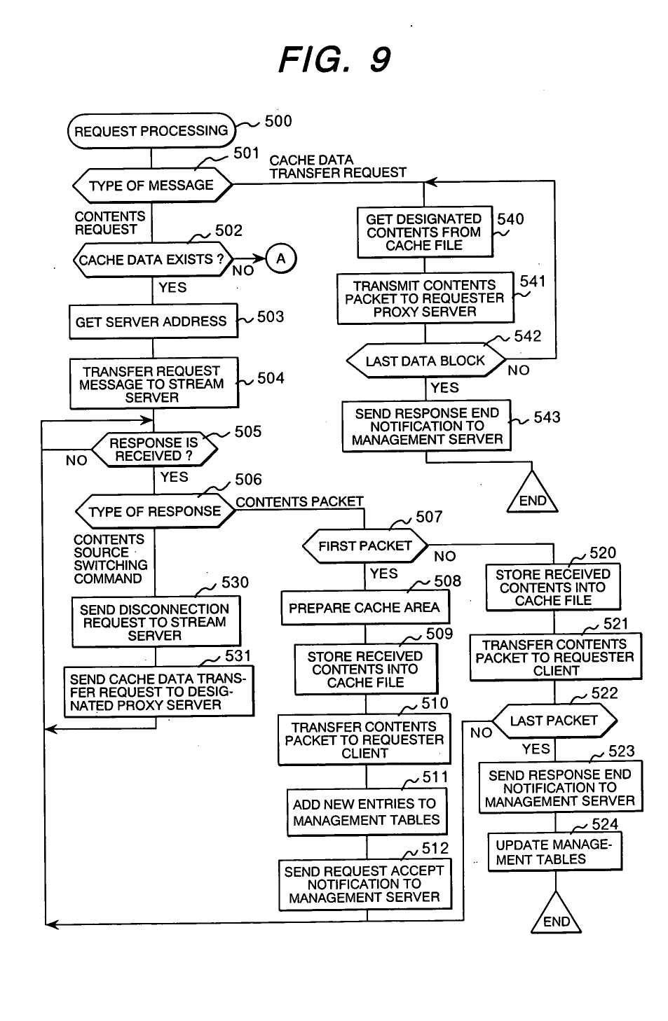

FIG. 9 shows a flowchart showing an example of a request processing routine 500 prepared in the program memory 51 of each proxy server 5 and executed by the processor 50 when a request message is received.

The processor 50 determines the type of the request message received (step 501). When the received message is the contents request M1 from a client, the processor 50 determines whether the requested contents is stored as cache data in the cache file 52 or not (502). The contents request M1 includes, as shown in FIG. 11, the type 101 of message, contents ID 102, and start position 103. In step 502, by referring to the cache table 58, the processor 50 makes a check to see whether an entry of which the contents ID 681 matches with the contents ID 102 and start position 683 satisfies the start position 103 has been registered or not.

If the requested contents has not been stored as cache data, the processor 50 retrieves a stream server address corresponding to the contents ID 102 from an address table not shown. When the stream server address is unknown, the processor 50 inquires the DNS 7 of the server address by designating the contents ID (503), transfers the contents request message to a stream server having the server address responded from the DNS 7 (504), and waits for the reception of a response packet (505).

At this time, the contents request message M1′ to be transferred to the stream server is obtained from the contents request M1 received from the client by rewriting the destination address in the IP header 11 to the stream server address, rewriting the source address to the proxy server address, and rewriting the source port number of the TCP header to the proxy port number.

When the response packet is received from the stream server, the processor 50 determines the type of the response (506). If the received response packet is a contents packet, the processor 50 determines whether the received packet is the first contents packet including the first data block of the contents stream or not (507). In the case of the first contents packet, after preparing a cache area for storing new stream contents in the cache file 52 (508), the processor 50 stores the contents data extracted from the received packet into the cache area (509). After that, the processor 50 converts the address of the received packet, and transfers the resultant packet to the client as the contents requester (510).

In this case, the processor 50 retrieves an entry whose destination IP address 671C matches with the source IP address of the received packet and whose proxy port number matches with the destination port number of the received packet from the connection table 57, rewrites the destination address and the destination port number of the IP header 11 to values of the IP address 671A and the port number 671B of the contents requester client indicated by the entry, rewrites the source IP address to the address of the switch 3, and transmits the received message to the switch 3. After that, the processor 50 adds new entries to the connection table 57 and the cache table 58 (511), transmits the notification of request accept M3 to the management server 6 (512), and returns to step 505 to waits for reception of the next response packet.

New entries to be added to the connection table 57 and the cache table 58 are comprised of a plurality of items similar to those of the entries in the connection table 67 and the cache table 68 for the management server described in FIGS. 6 and 7. These entries are generated according to the contents of the contents request M1 and the control parameters extracted from the first contents packet received from the stream server.

The notification of request accept M3 includes, as shown in FIG. 12, subsequently to the IP header 11, TCP header 12 and message ID 101, proxy server ID 111, connection ID 112, contents ID 102, request accept time 113, start position 103, size 114, necessary bandwidth 115, cache utilization flag 116, and contents source ID 117. As the proxy server ID 111 to contents source ID 117, the values of the proxy server ID 672 to the contents source ID 679 of the entry newly registered in the connection table 57 are set. At this time point, the size 114 indicates the value of the size 21 extracted from the control parameter field of the first contents packet, and the cache utilization flag 116 is in the state (“0”) indicating that the cache is not used.

When the received packet is a contents packet which includes one of data blocks subsequent to the first data block of the contents stream, the processor 50 stores contents data extracted from the received packet into the cache file (520), and after rewriting the header information of the received packet in a manner similar to the first received packet, transfers the resultant packet to the contents requester client (521). When the received packet is not the final contents packet including the last data block of the contents stream, the processor 50 returns to step 505 to wait for reception of the next response packet. When the received packet is the final contents packet, the processor 50 transmits the notification of response end M4 to the management server 6 (523). After that, the processor 50 eliminates an entry which became unnecessary from the connection table 57, sets “1” in the completion flag 686 of the corresponding entry in the cache table 58 (524), and terminates the contents request process.

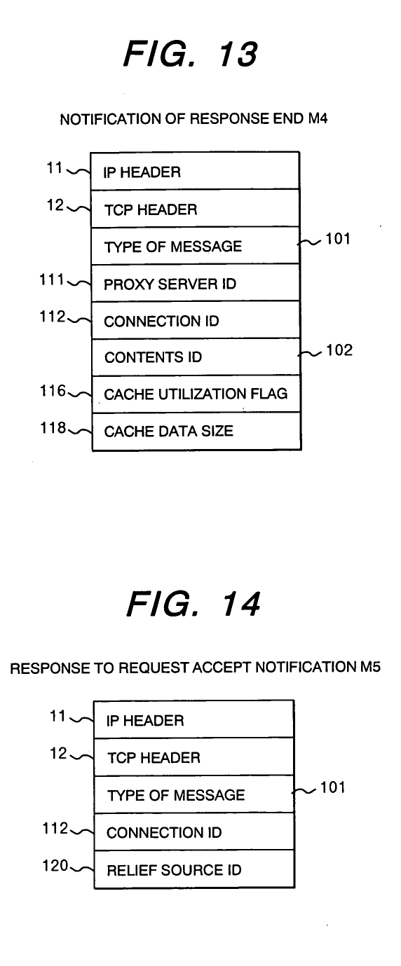

The notification of response end M4 includes, for example, as shown in FIG. 13, subsequently to the IP header 11, TCP header 12 and message ID 101, proxy server ID 111, connection ID 112, contents ID 102, cache utilization flag 116, and cache data size 118. The values of the proxy server ID 111 to cache utilization flag 116 are the same as the values of the notification of request accept M3, and the cache data size 118 indicates the data length of the contents stream actually stored in the cache file counted in steps 509 and 520.

When the response packet received in step 505 includes a source switching instruction issued from the management server 6, the processor 50 transmits a disconnection request for stopping the stream contents providing service to the stream server being accessed at present (530), transmits a cache data transfer request M2 to a proxy server designated by the source switching instruction (531), and returns to step 505.

The cache data transfer request M2 has the same format as that of the contents request M1 shown in FIG. 11. In the start position 103, the value indicative of the head position of a next data block subsequent to the data blocks already received from the stream server is set.

In step 501, if the received request message is the cache data transfer request M2 from another proxy server, the processor 50 reads out the stream contents designated by the request M2 from the cache file 52 (540). The contents data is read out on the unit basis of a data block having a predetermined length as described in FIG. 2. Each data block is transmitted to the requester proxy server as an IP packet having the IP header 11 and the TCP header 12 (541). When the last data block is sent out (542), the processor 50 transmits a response end notification to the management server (543), and terminates the cache data transfer request process.

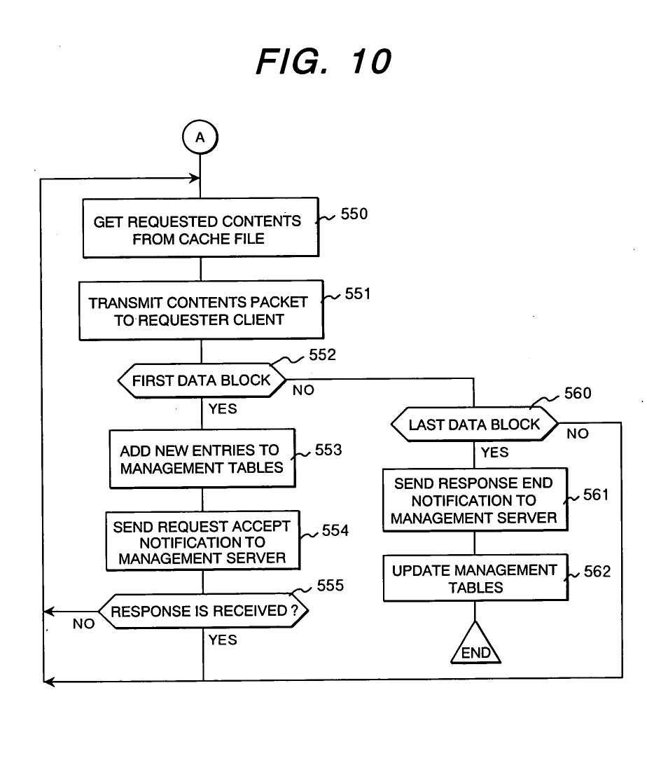

If the contents requested by the contents request M1 is already stored as cache data in step 502, as shown in FIG. 10, the processor 50 reads out the stream contents designated by the request M1 from the cache file 52 on the block unit basis as described in FIG. 2 (550) and transmits it as an IP packet to the requester client (551). When the first data block is transmitted (552), new entries are added to the connection table 57 and the cache table 58 (553), and the notification of request accept M3 is transmitted to the management server 6 (554). In this case, the cache utilization flag 116 of the notification of request accept M3 is set in the state of “1” indicating that the cache is in use.

To the notification of request accept M3, a response indicative of the current access continuation is returned from the management server 6. Consequently, the processor 50 returns to step 550 irrespective of reception of the response from the management server, and repeats the reading out of the next data block from the cache file 52 and the transmission of the contents packet to the requester client.

When the last data block in the contents stream is sent out, the processor 50 transmits the notification of response end M4 to the management server 6 (561), deletes the entry which became unnecessary from the connection table 57 (562), and terminates the contents request process.

As described above, the proxy server of the invention has the first mode of transmitting the contents received from the stream server to the client, the second mode of transferring the contents read out from the cache file to the client, the third mode of transferring the contents received from another proxy server to the client, and the fourth mode of transmitting the contents read out from the cache file to another proxy server. The switching over from the first mode operation to the third mode operation and the execution of the fourth mode operation are controlled by the management server 6.

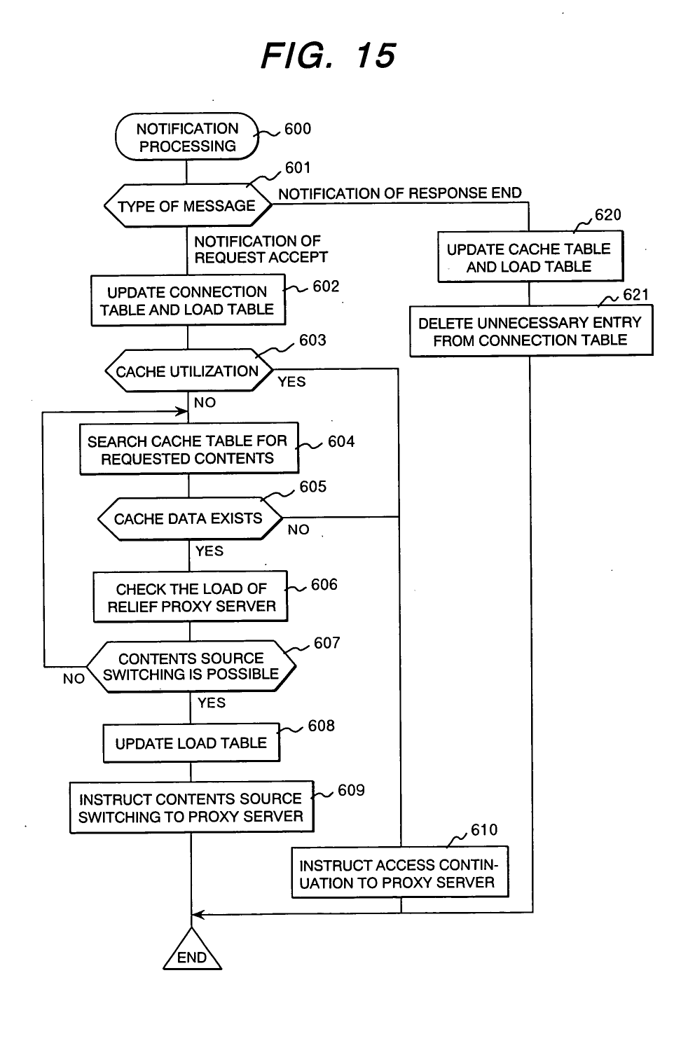

FIG. 15 is a flowchart showing an example of a notification processing routine 600 executed by the processor 60 of the management server 6.

The processor 60 determines the type of a notification message received from one of the proxy servers (step 601). When the received message is the notification of request accept M3, the processor 60 adds a new entry 670-j corresponding to the notification of request accept M3 to the connection table 67 and updates the load table 69 (602). The values of the source IP address 671A to the destination port number 671D of the entry 670-j are extracted from the IP header 11 and the TCP header 12 of the received message M3, and the values of the proxy server ID 672 to the contents source ID 679 are obtained from the proxy server ID 111 to the contents source ID 117 of the received message M3. In the updating of the load table 69, in an entry having the server ID 691 which coincides with the proxy server ID 111 of the notification of request accept M3, the value of the number 692 of connections is incremented, and the value of the size 114 indicated by the notification of request accept M3 is added to the value of the bandwidth 693 in use.

The processor 60 determines the cache utilization flag 116 of the notification of request accept M3 (603) and, when the cache utilizing state (“1”) is set, transmits a response to the request accept notification M5 instructing continuation of the current access to a proxy server which is the source of the notification of request accept M3 (610), and terminates the process.

The response to request accept notification M5 includes, for example, as shown in FIG. 14, the IP header 11, TCP header 12, and message type 101 and, subsequently, the connection ID 112 and a relief source ID 120. As the connection ID 112, the value of the connection ID 112 extracted from the notification of request accept M3 is set. In the case of instructing continuation of the current access to the requester proxy server, predetermined values (such as all “0”) are set to the relief source ID 120. From the values of the relief source ID 120, the proxy server can determine that the received message M5 indicates the source switching or continuation of the current access.

When the cache utilization flag 116 of the notification of request accept M3 indicates the cache unused state (“0”), the processor 60 retrieves an entry whose contents ID 681 coincides with the contents ID 102 of the notification of request accept M3 from the cache table 68 (604). When the entry 680-j matching with the contents ID 102 is found, the processor 60 retrieves an entry 690-k whose server ID 691 coincides with the proxy server ID 684 of the entry 680-j from the load table 69, and determines the load state of the proxy server which is a candidate for a relief proxy server (606).

The load state of the relief proxy server can be determined by comparing the values of the number 692 of connections and the bandwidth 693 in use of the entry 690-k with the maximum number 694 and the upper limit 695, respectively, to check whether a predetermined threshold state is reached or not. For example, when the number of connections incremented exceeds the maximum number 694 or when the value obtained by adding the value of the necessary bandwidth 115 indicated by the notification of request accept M3 to the value of the bandwidth 692 in use exceeds the value of the upper limit 695, a heavy load state may be determined.

In the case of the heavy load state (source switching unable state) where the proxy server to be a candidate for the relief proxy server cannot accept a new load (607), the processor 60 returns to step 604, retrieves a new candidate entry which coincides with the contents ID 102 from the cache management table 68, and repeats operations similar to the above.

In the case where the proxy server to be a relief proxy server is in a light load state, the processor 60 increments the value of the number 692 of connections of the entry 690-k, adds the value of the size 114 indicated by the notification of request accept M3 to the value of the bandwidth 693 in use (608), after that, generates a request accept notification response M5 (source switching instruction) in which the value of the server ID 691 of the entry 690-k is set as the relief source ID 120, and transmits the response M5 to the proxy server which is the source of the notification of request accept M3 (609).

When the searching of the cache table 68 is completed without finding a relief proxy server (605), the processor 60 transmits a response to the request accept notification M5 indicative of continuation of the current access to the source proxy server of the notification of request accept M3 (610), and terminates the process.

In the case where the received message is the notification of response end M4 in step 601, the processor 60 updates the cache table 68 and the load table 69 on the basis of the contents ID 102 and proxy server ID 111 of the notification M4, (620). In this case, for example, the processor 60 retrieves an entry 680-j having the contents ID 681 and proxy server ID 684 matching with the contents ID 102 and proxy server ID 111 from the cache table 68, and obtains the size 682. Subsequently, the processor 60 retrieves an entry matching with the proxy server ID 111 from the load table 69, decrements the value of the number 692 of connections and, after that, subtracts the value indicated by the size 682 from the value of the bandwidth 693 in use. In the entry 680-j of the cache table 68, the processor 60 rewrites the value of the size 682 to the value of the cache data size 117 indicated by the notification of response end M4, and sets the completion flag 686 into the completion state (“1”).

After that, the processor 60 deletes an entry (unnecessary entry) whose proxy server ID 672 and connection ID 673 coincide with the proxy server ID 111 and connection ID 112 of the notification of response end M4 from the connection table 67 (621) and terminates the process of the notification of response end M4.

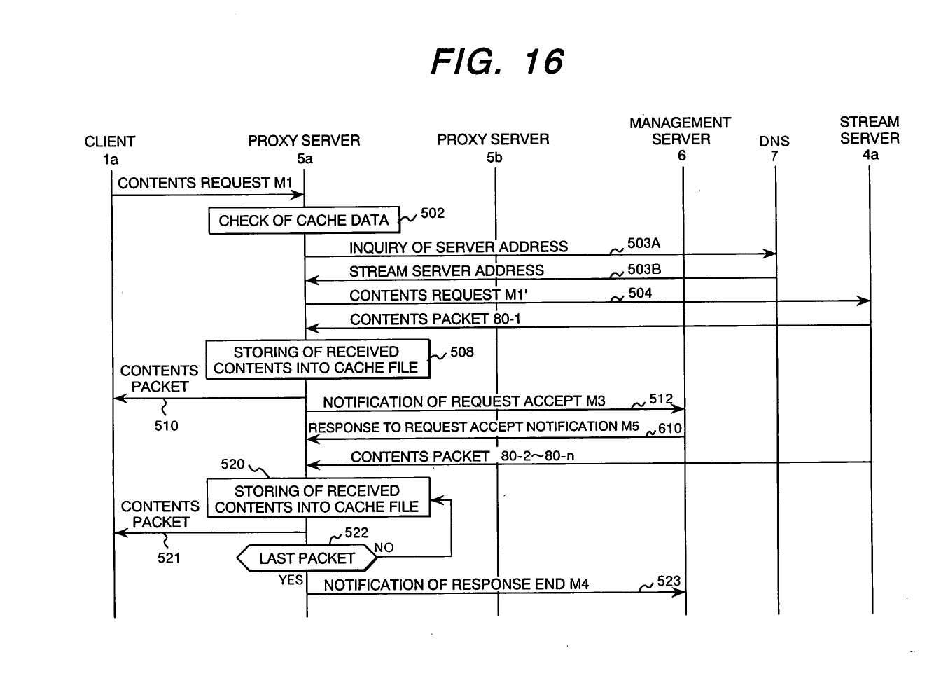

FIG. 16 shows a message flow of the case where there is no cache data of the requested contents in the proxy server 5a and other proxy servers when the contents request M1 from the client 1a is assigned to the proxy server 5a in the system shown in FIG. 1. To clarify the relation between the functions of the proxy server and those of the management server have been already described, the same reference numerals as those in FIGS. 9, 10, and 15 are used here.

The proxy server 5a determines whether cache data exists or not (502). When it is determined that there is no cache data of the requested contents in the cache file 52, the proxy server 5a inquires the DNS 7 of a server address (503A). On receipt of notification of the server address from the DNS 7 (503B), the proxy server 5a transmits the address-converted contents request M1′ to a designated server, for example, the stream server 4a (504). By the operation, transmission of a contents packet from the stream server 4a to the proxy server 5a is started.

When the first contents packet 80-1 is received, the proxy server 5a stores it into the cache file (508), transfers the contents packet to the requester client 1a after rewriting the packet addresses, and transmits the notification of request accept M3 to the management server 6 (512). In this example, there is no cache data of the requested contents also in the other proxy servers, the management server 6 transmits the response to request accept notification M5 instructing continuation of the current access to the proxy server 5a (610). Accordingly, the proxy server 5a stores the contents packets 80-2 to 80-n received thereafter into the cache file (520) and transfers these packets to the requester client 1a after rewriting the packet addresses (521). When the last contents packet 80-n is transferred, the proxy server 5a transmits the notification of response end M4 to the management server 6 (523), and terminates the operation of processing the contents request M1.

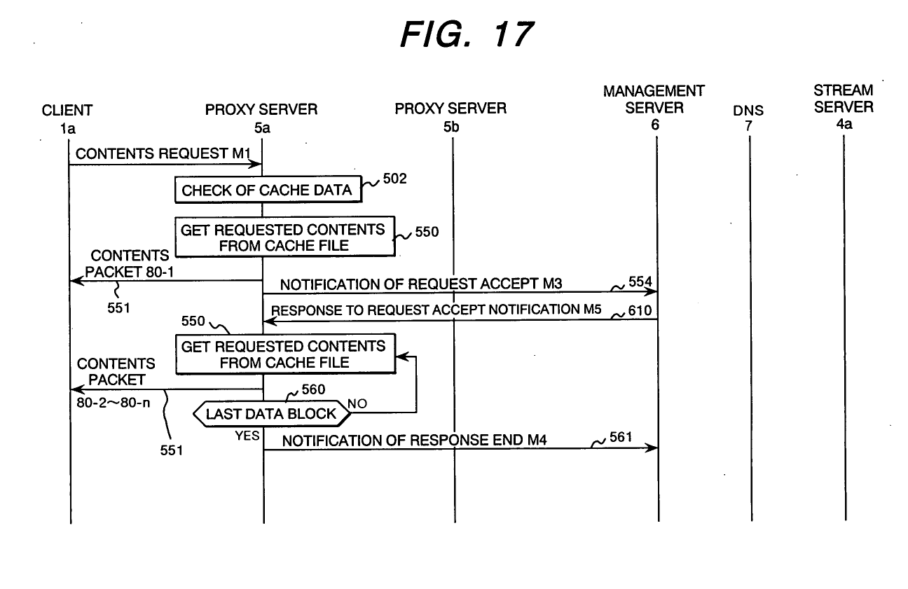

FIG. 17 shows a message flow of the case where the proxy server 5a having received the contents request M1 from the client 1a has cache data of the requested contents.

When it is found that there is cache data of the requested contents in the cache file 52, the proxy server 5a reads out the first data block of the stream contents from the cache file, transfers the block as the IP packet 80-1 to the client 1a (551), and transmits the notification of request accept M3 to the management server 6 (554). The management server 6 transmits the response to request accept notification M5 instructing continuation of the current access to the proxy server 5a (610). Therefore, the proxy server 5a sequentially reads out subsequent contents data blocks from the cache file (550), and transfers the data blocks as contents packets 80-2 to 80-n to the client 1a (551). When the last contents packet 80-n is transferred, the proxy server 5a transmits the notification of response end M4 to the management server 6 (561), and terminates the operation of processing the contents request M1.

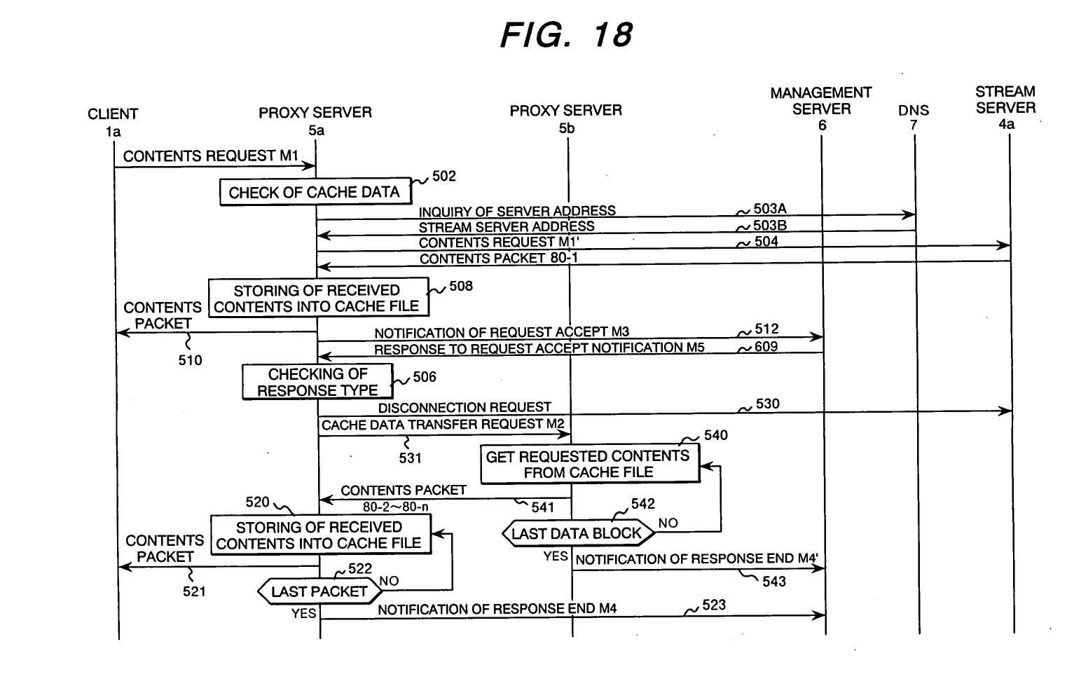

FIG. 18 shows a message flow of the case where cache data of the contents requested from the client 1a does not exist in the proxy server 5a which has received the request but exists in another proxy server 5b.

The operation sequence up to transmission of the notification of request accept M3 from the proxy server 5a to the management server 6 (512) is similar to that of FIG. 16. When it is found that there is the cache data of the requested contents in the proxy server 5b and the proxy server 5b can transfer the cache data to the proxy server 5a, the management server 6 transmits the response to the request accept notification M5 indicative of the source switching instruction to the proxy server 5a (609).

When the response to request accept notification M5 is received, the proxy server 5a sends a disconnection request to the stream server 4a which is being accessed (530), and transmits the cache data transfer request M2 to the proxy server 5b designated by the response M5 (531). When the cache data transfer request M2 is received, the proxy server 5b reads out the designated contents data from the cache file (540), and transmits the contents data as the contents packets 80-2 to 80-n to the requester proxy server 5a (541). When the last contents packet 80-n is transferred (542), the proxy server 5b transmits the notification of response end M4′ to the management server 6 (543) and terminates the operation of processing the request M2.

The proxy server 5a stores the contents data received from the proxy server 5b into the cache file 52 (520) and transfers the received packet to the requester client 1a (521). When the final content packet is transferred to the client 1a (522), the proxy server 5a transmits the notification of response end M4 to the management server 6 (523) and terminates the process on the request M3.

According to the above embodiment, the management server 6 retrieves a proxy server which can accept the cache data transfer request by referring to the cache table 68 and the load table 69. For example, in the case where the cache data of the requested contents is stored in a plurality of proxy servers, it is also possible to find a server on which the load is the lightest among the proxy servers and designate the server as a relief proxy server.

In the embodiment, at the time when the last data block of the stream contents is transmitted to the client, the notification of response end is transmitted from each proxy server to the management server and the size of the contents data actually stored in the cache file is notified to the management server. Alternately, each proxy server may notify the management server of the storage amount of the contents data every moment and the management server may select a relief proxy server in consideration of the storage amount of contents data (cache data).

With respect to the contents data storage amount, it is sufficient to, for example, count the length of the contents data in step 520 in the flowchart of FIG. 9 and, each time an increased amount of the data length reaches a predetermined value, send a notification to the management server. It is also possible to count the number of contents packets received for each stream and notify the management server of the present contents data length every N packets.

In the case where the proxy server invalidates any existing stream contents to prepare a cache area for new stream contents in step 508 in the flowchart of FIG. 9, the proxy server and the management server have to delete entries corresponding to the invalidated stream contents from the cache tables 58 and 68, respectively, synchronously with each other. To realize such updating of the cache tables, for example, the ID of the invalidated contents may be added next to the contents ID 117 of the notification of request accept M3 shown in FIG. 12, so as to notify the management server of the invalidated stream contents. In this case, the management server can delete the entry corresponding to the ID of the invalidated contents from the cache table 68 in step 602 in the flowchart of FIG. 15. To select stream contents (cache data) to be invalidated, various algorithms can be applied. The simplest method is, for example, to store the latest use time of cache data into the cache table 58 and select the oldest entry among registered entries by referring to the time information. It is sufficient to set the registration time of the cache data newly registered in the cache file as an initial value of the latest use time and update the value of the latest use time, for example, at the time of execution of step 553 in FIG. 10.

In the foregoing embodiment, the management server 6 uses the load table 69 as a table for monitoring loads on the proxy servers 5a to 5k. It is also possible to prepare a load table 69B for a stream server separately from the load table 69 for the proxy servers, and regulate execution of the contents request by the management server in accordance with the load states of the stream servers. The load table 69B for stream servers has the same configuration as that of the load table 69 for proxy servers, and is comprised of a plurality of entries each including the stream server ID as the server ID 601.

The load table 69B can be updated, for example, in step 602 in the flowchart show in FIG. 15. Specifically, when a check is made to see the cache utilization flag of the received notification of request accept M3 and “0” is set in the flag, the load table 69B is referred to on the basis of the contents source ID 117 and an entry whose server ID 691 coincides with the contents source ID 117 is retrieved, thereby enabling the values of the number 692 of connections and the bandwidth 693 in use to be updated in a manner similar to the load table 69 for proxy servers. With respect to regulation on execution of the contents request, for example, when the updated values of the number 692 of connections and the bandwidth 693 in use are compared with the maximum number 694 and the upper limit 695, respectively, and either the number of connections or the bandwidth in use exceeds the maximum number or upper limit, the management server may transmit a response message including an access stop instruction to the proxy server as a transmitter of the notification of request accept M3.

The response message including the access stop instruction is received in step 505 in the flowchart shown in FIG. 9 and discriminated in step 506. Therefore, on receipt of the access stop instruction, it is sufficient to allow each proxy server to send a disconnection request to the stream server and transmit a message to notify the client as the contents requester of stop of the contents providing service due to a busy state. As described above, by interrupting execution of a contents request newly generated when the stream server is in a heavily loaded state, deterioration in quality of the contents distribution services being provided at present can be avoided.

With the configuration of the invention, even in the case of allocating the contents requests to the proxy servers irrespective of the contents ID, all the proxy servers can share the cache data, so that the load on the stream server can be reduced. Further, by providing a plurality of proxy servers with cache data of the same stream, the contents requests on a popular stream can be processed by the plurality of proxy servers in parallel.

1. A proxy server comprising:
a file for storing contents data extracted from contents packets received from a stream server as cache data of stream contents;
means for transferring the contents packets received from said stream server to a contents requester after rewriting address information of the received packets; and
first means for requesting the stream server as a source of said contents packet to stop the stream contents providing service and requesting another proxy server to transfer the remaining portion of said stream contents.

2. The proxy server according to claim 1, further comprising:
second means for reading out stream contents from said file when a contents request is received from a client and the stream contents designated by the contents request exists as cache data in said file, and transmitting the stream contents in a form of a series of contents packets to the requester client;
third means for requesting said stream server to transmit stream contents when the stream contents designated by the contents request does not exist as cache data in said file; and
fourth means for transmitting a notification of request accept including a contents ID designated by the contents request to a management server,
wherein said first means issues a providing service stop request to said stream server and a stream contents transfer request to said another proxy server in accordance with a response to said notification from said management server.

3. The proxy server according to claim 1, further comprising means for reading out, when a contents request is received from another proxy server, stream contents matching with said contents request from said file and transmitting the stream contents in a form of a series of contents packets to the requester proxy server.

4. A stream contents distribution system comprising:
at least one stream server for providing stream contents distributing service in response to a contents request;
a plurality of proxy servers each having a file for storing stream contents as cache data; and
a switch for performing packet exchange among said proxy servers, stream server, and a communication network and allocating contents requests received from said communication network to said proxy servers; and each of said proxy servers comprising:
means for reading out, when a contents request is received from a client and stream contents designated by the contents request exists as cache data in said file, the stream contents from said file and transmitting the stream contents in a form of a series of contents packets to a requester client via the switch;
means for requesting said stream server to transmit the stream contents when the stream contents designated by the contents request does not exist as cache data in said file;
means for storing, when a contents packet is received from said stream server, the contents data extracted from the received packet as cache data of the stream contents into said file, and transferring the received packet to a requester client after rewriting address information of the received packet; and
means for requesting said stream server to stop contents providing service and requesting another proxy server to transfer the remaining portion of said stream contents.

5. The stream contents distribution system according to claim 4, further comprising a management server for performing communication with each of said proxy servers via said switch and collecting management information regarding cache data held by each of said proxy servers,
wherein each of said proxy servers transmits a notification of request accept including a contents ID designated by the contents request to said management server and, in accordance with a response to the notification from said management server, issue a contents providing service stop request to said stream server and a stream contents transfer request to said another proxy server.

6. The stream contents distribution system according to claim 5, wherein said management server includes means for determining the presence or absence of cache data corresponding to a contents ID indicated by said notification of request accept in accordance with said management information and transmitting said response designating a relief proxy server to the proxy server as the source of said notification when the cache data exists in another proxy server.

7. The stream contents distribution system according to claim 5, wherein each of said proxy servers includes means for reading out, when a contents request is received from another proxy server, stream contents matching with the request from said file and transmitting the stream contents in a form of a series of contents packets to said another proxy server.

8. The stream contents distribution system according to claim 6, wherein said management server has a load table for managing a load state of each of said proxy servers and, when said notification of request accept is received, selects the relief proxy server by referring to the load management table.

9. The stream contents distribution system according to claim 6, wherein said management server has a second load table for managing a load state of said stream server, refers to the second load table when said notification of request accept is received, and returns a response designating stop of service to the proxy server as the source of the notification when said stream server enters an overload state.
